(19) United States
(12) Patent Application Publication
(10) Pub. No.: US 2013/0002978 A1
(43) Pub. Date: Jan. 3, 2013

(54) LIQUID CRYSTAL DISPLAY MODULE

(75) Inventor: Gang Yu, Shenzhen (CN)

(73) Assignee: Shenzhen China Star Optoelectronics Technology Co. Ltd., Shenzhen, Guangdong (CN)

(21) Appl. No.: 13/376,197

(22) PCT Filed: Sep. 21, 2011
(86) PCT No.: PCT/CN11/79927

§ 371 Date: Dec. 5, 2011

(30) Foreign Application Priority Data
Jun. 28, 2011 (CN) 201110176726.7

(51) Int. Cl. G02F 1/1333

(52) U.S. Cl. 349/58

(57) ABSTRACT

A liquid crystal display module comprises a backplate and a light source assembly disposed within the backplate. The backplate is a hexahedron which is open at the top, and the light source assembly comprises a light source and a light source support. The backplate has an open side edge that is completely open, and side edges located at two sides of the open side edge are each formed with a snap-fit hole respectively. The light source support is provided with snap-fit elements for being detachably joined with the snap-fit holes, and the light source assembly is inserted into the backplate from the open side edge with the snap-fit elements being mated with the snap-fit holes to fix the light source assembly and the backplate together. The liquid crystal display module and the LCD device can effectively decrease the complexity in replacing the light source and reduce potential damage to components.

### BACKGROUND

1. Technical Field

The present disclosure relates to a liquid crystal display module, and more particularly, to a liquid crystal display module of decreasing the complexity in replacing the light source.

2. Description of Related Art

As is well known, liquid crystal display (LCD) modules are a kind of important components in LCD devices. An LCD module generally comprises a light source assembly, a backplate and a light guide panel. Referring to FIG. 1, there is shown a schematic exploded structural view of a prior art LCD module. When it is necessary to replace the light source, the maintenance personnel must firstly detach the whole backlight module from the LCD device and then detach the liquid crystal panel 200, the front frame 300, the plastic frame 400, the first optical film 510, the second optical film 520, the light guide panel 530 and the reflective sheet 540 before they can remove the light source 120 to replace the damaged light source 110 of the light source assembly 120. This replacing procedure is not only complex, but also tends to cause damage to other peripheral components during the detaching process.

### BRIEF SUMMARY OF THE DISCLOSURE

A primary objective of the present disclosure is to provide a liquid crystal display module that can decrease the complexity in replacing the light source and reduce potential damage to components.

To achieve the aforesaid objective, the present disclosure provides a liquid crystal display module, which comprises a backplate and a light source assembly disposed within the backplate. The backplate is a hexahedron which is open at the top, and the light source assembly comprises a light source and a light source support. The backplate has an open side edge that is completely open, and side edges located at two sides of the open side edge are each formed with a snap-fit hole respectively. The light source support is provided with snap-fit elements adapted to be detachably joined with the snap-fit holes, and the light source assembly is inserted into the backplate from the open side edge with the snap-fit elements being mated with the snap-fit holes to fix the light source assembly and the backplate together.

Preferably, the snap-fit element comprises:

a stopping support having a first vertical end and a second vertical end spaced apart from each other, wherein the first vertical end is adjacent to one of the side edges having a snap-fit hole and is formed with a through-hole corresponding to the snap-fit hole; and

a dowel pin having one end inserted into the snap-fit hole via the through-hole and the other end abutting against an elastic element.

Preferably, a top surface of the end of the dowel pin that is inserted into the snap-fit hole is a convex cambered surface.

Preferably, the elastic element is a spring.

Preferably, the stopping support is inserted or snap-fitted into the light source support.

Preferably, the second vertical end is provided with a locating hole or a locating post for mating with the elastic element, and a first end of the elastic element is located on the second vertical end by means of the locating hole or the locating post.

Preferably, the stopping support is disposed in the form of a rectangular archway, with the first vertical end and the second vertical end standing vertically at two sides of the stopping support respectively; the light source support is formed with a first locating groove for mating with the first vertical end and a second locating groove for mating with the second vertical end, a third locating groove for receiving the elastic element is formed between the first locating groove and the second locating groove, and the third locating groove communicates with the first locating groove and is co-axial with the through hole.

Preferably, the light source support has a short edge and a long edge perpendicular to the short edge, the short edge connects with the light source and the long edge is adapted to locate the snap-fit element.

The present disclosure further provides a liquid crystal display (LCD) device which comprises a liquid crystal display module. The liquid crystal display module comprises a backplate and a light source assembly disposed within the backplate. The backplate is a hexahedron which is open at the top, and the light source assembly comprises a light source and a light source support. The backplate has an open side edge that is completely open, and side edges located at two sides of the open side edge are each formed with a snap-fit hole respectively. The light source support is provided with snap-fit elements adapted to be detachably joined with the snap-fit holes, and the light source assembly is inserted into the backplate from the open side edge with the snap-fit elements being mated with the snap-fit holes to fix the light source assembly and the backplate together.

In the liquid crystal display module of the LCD device of the present disclosure, the light source assembly is inserted into the backplate from the open side edge of the backplate and is detachably joined with the backplate. Thereby, during a detaching process, the light source assembly can be withdrawn directly from the backplate without having to detach other parts. This decreases the complexity in replacing the light source and reduces potential damage to components.

### BRIEF DESCRIPTION OF THE DRAWINGS

FIG. 1 is a schematic structural view of a prior art liquid crystal display module;

FIG. 2 is a schematic structural view of a first embodiment of a liquid crystal display module according to the present disclosure;

FIG. 3 is a schematic exploded structural view of a light source assembly in the first embodiment of the liquid crystal display module according to the present disclosure;

FIG. 4 is a partial enlarged view of a portion A shown in FIG. 3; and

FIG. 5 is a schematic partial structural view of a light source assembly and a light source support in a second embodiment of the liquid crystal module according to the present disclosure.

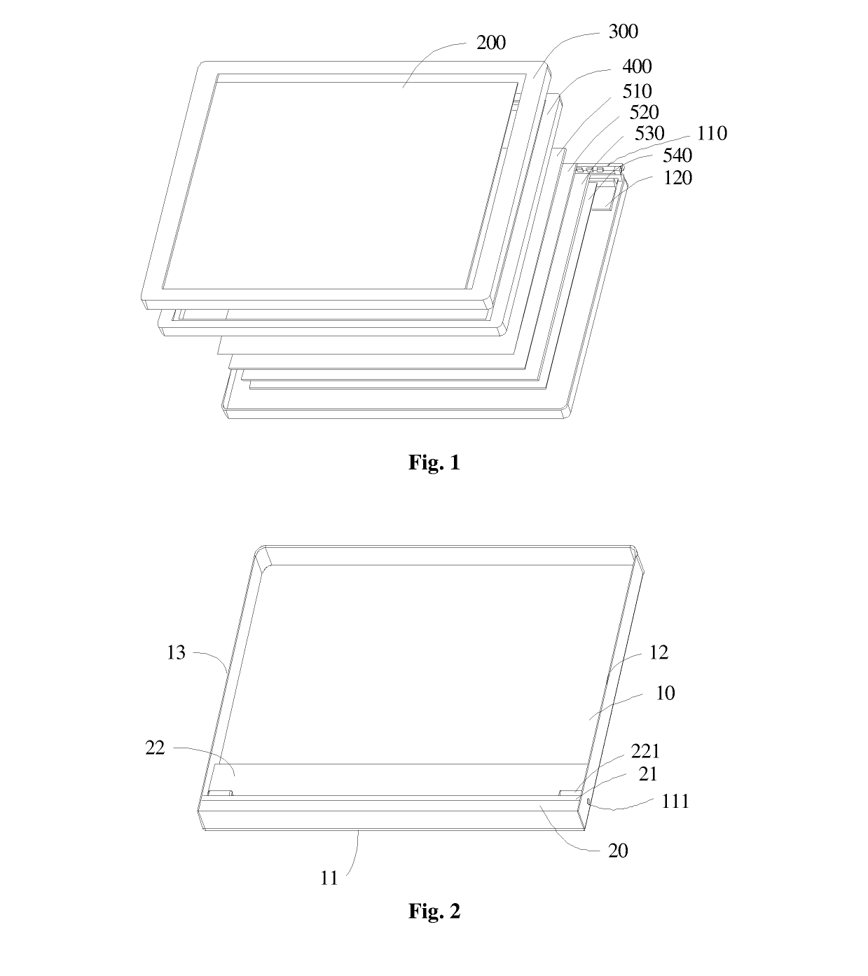

Hereinafter, implementations, functional features and advantages of the present disclosure will be further described with reference to embodiments thereof and the attached drawings.

### DETAILED DESCRIPTION

It shall be understood that, the embodiments described herein are only intended to illustrate but not to limit the present disclosure.

Referring to FIG. 2, there is shown a schematic structural view of a first embodiment of a liquid crystal display module according to the present disclosure.

In this embodiment, the liquid crystal display module comprises a backplate 10 and a light source assembly 20 disposed within the backplate 10. The backplate 10 is a rectangular plastic enclosure which is open at the top. The backplate 10 further has an open side edge 11 that is completely open, through which the light source assembly 20 is inserted into the backplate 10 like a drawer. Upon passing through the open side edge 11 completely, the light source assembly 20 is located within the backplate 10. Specifically, at least one of a first side edge 12 and a second side edge 13, which are located at both sides of the open side edge 11 respectively, of the backplate 10 is formed with a snap-fit hole 111. The light source assembly 20 comprises a light source 21 and a light source support 22, with the light source 21 being disposed on the light source support 22. Two ends of the light source support 22 abut against the first side edge 12 and the second side edge 13 respectively. The light source support 22 is provided with a snap-fit element 221 adapted to be detachably joined with the snap-fit hole 111. The light source support 22 has a short edge and a long edge perpendicular to the short edge. The short edge is adapted to connect with the light source 21, and the long edge is adapted to locate the snap-fit element 221. Once the light source assembly 20 is inserted through the open side edge 11 completely, the snap-fit element 221 mates with the snap-fit hole 111 to locate the light source assembly 20 on the backplate 10. In this embodiment, there may be various ways in which the snap-fit hole 111 and the snap-fit element 221 mate with each other for locating purpose; for example, the snap-fit hole 111 may be a circular hole, a square hole or an elliptical hole and, correspondingly, the snap-fit element 221 may comprise a cylinder, a cuboid or an ellipsoid that can be inserted into the snap-fit hole 111 and that is retractable. The first side edge 12 and/or the second side edge 13 of the backplate 10 may be formed with only one snap-fit hole 111, or be formed with a plurality of snap-fit holes 111 arranged linearly. Preferably in this embodiment, the first side edge 12 and the second side edge 13 are each formed with one snap-fit hole 111, and the two snap-fit holes 111 are of the same shape and the same size and located at corresponding locations. The snap-fit hole formed in the second side edge 13 is not shown herein.

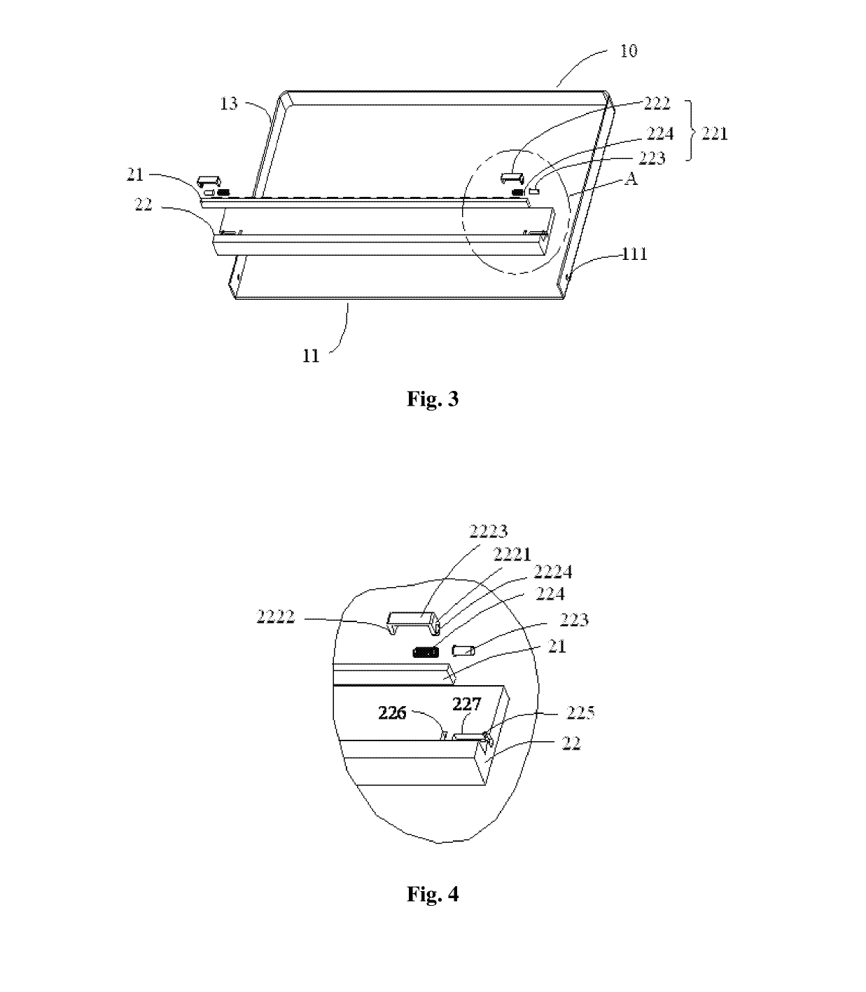

A preferred structure of the snap-fit element 221 in this embodiment is shown in FIG. 3 and FIG. 4. FIG. 3 is a schematic exploded structural view of a light source assembly 20 in the liquid crystal display module of this embodiment, and FIG. 4 is a partial enlarged view of a portion A shown in FIG. 3. As shown in FIG. 3 and FIG. 4, the snap-fit element 221 comprises a stopping support 222, a dowel pin 223 and an elastic element 224.

The stopping support 222 is disposed on the light source support 22 at the side of the light source 21. The stopping support 222 has a first vertical end 2221 and a second vertical end 2222 spaced apart from and opposite to each other. Specifically, the first vertical end 2221 and the second vertical end 2222 are two plate-shaped bodies in parallel and connected with each other by a traverse section 2223. The first vertical end 2221, the second vertical end 2222 and the traverse section 2223 together form the stopping support 222 in an archway form. The first vertical end 2221 is adjacent to a side of the backplate 10 that is formed with the snap-fit hole 111 during the assembling process, and is formed with a through-hole 2224 corresponding to the snap-fit hole 111. By “the through-hole 2224 corresponding to the snap-fit hole 111”, it means that the through-hole 2224 is located at a location corresponding to that of the snap-fit element 111 and has substantially the same form and the same size as the snap-fit hole 111. The stopping support 222 may be joined with the light source support 22 in various ways, for example, by being inserted into or snap-fitted into the light source support 22. As shown in FIG. 4, preferably in this embodiment, the light source support 22 is formed with a first locating groove 225 for mating with the first vertical end 2221 and a second locating groove 226 for mating with the second vertical end 2222. A span between the first locating groove 225 and the second locating groove 226 is equal to a distance between the first vertical end 2221 and the second vertical end 2222. The first vertical end 2221 and the second vertical end 2222 can be inserted into the first locating groove 225 and the second locating groove 226 respectively so that the stopping support 222 is joined with the light source support 22. Additionally, a third locating groove 227 is also formed between the first locating groove 225 and the second locating groove 226 to locate the elastic element 224. The third locating groove 227 is co-axial with the through-hole 2224 and communicates with the first locating groove 225. At an outer side of the first locating groove 225 is formed a notch for limiting a swing extent of the dowel pin 223. Size of the notch matches that of the dowel pin 223 so that the dowel pin 223 can be withdrawn from or inserted into the snap-fit hole 111 successfully without swing too much.

The dowel pin 223 has one end inserted into the snap-fit hole 111 via the through-hole 2224 and the other end abutting against an elastic element. The form of the dowel pin 223 matches that of the snap-fit hole 111, and may be a square form, a circular form or an elliptical form. Further, in this embodiment of the present disclosure, the end of the dowel pin 223 that abuts against the elastic element has a larger size than the other end of the dowel pin that is inserted into the snap-fit hole 111, and this can prevent the dowel pin 223 from being ejected out of the stopping support 222 when being subjected to a great force. In this embodiment, a top surface of the end of the dowel pin 223 that is inserted into the snap-fit hole 111 is a convex cambered surface, which allows the dowel pin 223 to be inserted into or withdrawn from the snap-fit hole 111 smoothly. Even further, the dowel pin 223 may also be implemented as a plurality of roll balls, which mate with a plurality of snap-fit holes 111 (e.g., the plurality of snap-fit holes 111 arranged linearly on the first side edge 12 and/or the second side edge 13 of the backplate 10) correspondingly to fix the light source assembly 20 and the backplate 10 together. Thus, instead of having to apply a force laterally to disengage the dowel pin 223 from the snap-fit hole 111, the light source assembly 20 can be attached to or detached from the backplate 10 by being pushed into or pulled from the backplate 10, which makes detachment of the light source assembly 20 more convenient.

The elastic element 224 has a first end and a second end opposite to each other. The first end is fixed, and the second end abuts against a tail end of the dowel pin 223. The elastic element 224 may be a spring (e.g., a straight helical spring, a V-shaped spring or a U-shaped spring) or a V-shaped plastic sheet having elasticity, and in this embodiment, is preferably a straight helical spring. By use of the elastic element 224, the dowel pin 223 can be linearly extended or retracted so as to be inserted into or withdrawn from the snap-fit hole 111, thus achieving detachable connection of the light source assembly 20 with the backplate 10.

In this embodiment, detachment of the light source assembly 20 can be accomplished simply by disengaging the dowel pin 223 from the snap-fit hole 111 and then withdrawing the light source assembly 20 from the backplate 10 just like a drawer without having to detach other parts. This remarkably decreases the difficulty in replacing the light source 21 and reduces potential damage to components.

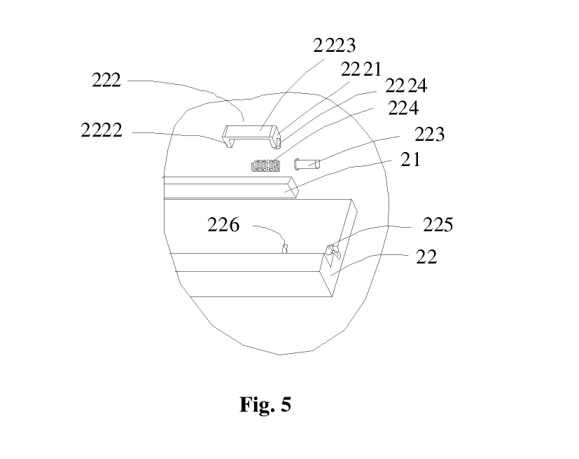

Referring to FIG. 5, there is shown a schematic partial structural view of the light source assembly 20 and the light source support 22 of a liquid crystal display module in a second embodiment according to the present disclosure. The liquid crystal display module of this embodiment differs from that of the first embodiment in that, the elastic element 224 is located on the stopping support 222. As shown in FIG. 5, the light source support 22 is formed with a first locating groove 225 for mating with the first vertical end 2221 and a second locating groove 226 for mating with the second vertical end 2222. A span between the first locating groove 225 and the second locating groove 226 is equal to a distance between the first vertical end 2221 and the second vertical end 2222. The first vertical end 2221 and the second vertical end 2222 can be inserted into the first locating groove 225 and the second locating groove 226 respectively so that the stopping support 222 is joined with the light source support 22. In this embodiment, a blind hole (not shown) for locating the elastic element 224 is formed at an inner side of the second vertical end 2222 of the archway-shaped stopping support 222, and a first end of the elastic element 224 is located on the second vertical end 2222 by means of the blind hole. Apart from forming the blind hole in the second vertical end 222, a locating post (not shown) may also be disposed on an inner side of the second vertical end 2222 to locate the elastic element 224 in this embodiment.

In the first embodiment or the second embodiment described above, both side edges (i.e., the first side edge 12 and the second side edge 13) at two sides of the open side edge of the backplate 10 are formed with a snap-fit hole 111. The snap-fit holes 111 on the two side edges may be disposed either opposite to each other or not opposite to each other, and preferably are opposite to each other. The snap-fit elements 221 are divided into two groups corresponding to the snap-fit holes 111.

The present disclosure further provides an LCD device, which may be applied in an LCD TV set. In addition to the liquid crystal display module described in the first embodiment or that described in the second embodiment, the LCD device further comprises a front frame, a light guide panel and other parts. Because the aforesaid structure of the liquid crystal display module is adopted in the LCD device, the light source assembly 20 can be withdrawn from the backplate 10 directly during the detaching process without having to detach other parts. This decreases the complexity in replacing the light source 21 of the light source assembly 20 and reduces potential damage to components. Thereby, both the manufacturing cost and the maintenance cost of the LCD device are remarkably lowered, which makes the LCD device and products incorporating the same more competitive in the market.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

What is claimed is:

1. A liquid crystal display module, comprising a backplate and a light source assembly disposed within the backplate, the backplate being a hexahedron which is open at the top, and the light source assembly comprising a light source and a light source support, wherein the backplate has an open side edge that is completely open, and side edges located at two sides of the open side edge are each formed with a snap-fit hole respectively; the light source support is provided with snap-fit elements adapted to be detachably joined with the snap-fit holes, and the light source assembly is inserted into the backplate from the open side edge with the snap-fit elements being mated with the snap-fit holes to fix the light source assembly and the backplate together.

2. The liquid crystal display module of claim 1, wherein the snap-fit element comprises:
a stopping support having a first vertical end and a second vertical end spaced apart from each other, wherein the first vertical end is adjacent to one of the side edges having a snap-fit hole and is formed with a through-hole corresponding to the snap-fit hole; and
a dowel pin having one end inserted into the snap-fit hole via the through-hole and the other end abutting against an elastic element.

3. The liquid crystal display module of claim 2, wherein a top surface of the end of the dowel pin that is inserted into the snap-fit hole is a convex cambered surface.

4. The liquid crystal display module of claim 3, wherein the elastic element is a spring.

5. The liquid crystal display module of claim 4, wherein the stopping support is inserted or snap-fitted into the light source support.

6. The liquid crystal display module of claim 5, wherein the second vertical end is provided with a locating hole or a locating post for mating with the elastic element, and a first end of the elastic element is located on the second vertical end by means of the locating hole or the locating post.

7. The liquid crystal display module of claim 5, wherein the stopping support is disposed in the form of a rectangular archway, with the first vertical end and the second vertical end standing vertically at two sides of the stopping support respectively; the light source support is formed with a first locating groove for mating with the first vertical end and a second locating groove for mating with the second vertical end, a third locating groove for receiving the elastic element is formed between the first locating groove and the second locating groove, and the third locating groove communicates with the first locating groove and is co-axial with the through hole.

8. The liquid crystal display module of claim 1, wherein the light source support has a short edge and a long edge perpendicular to the short edge, the short edge connects with the light source and the long edge is adapted to locate the snap-fit element.

9. The liquid crystal display module of claim 8, wherein the snap-fit element is a snap-fit tongue protruding from a side surface of the long edge and having elasticity.

10. A liquid crystal display (LCD) device comprising a liquid crystal display module, the liquid crystal display module comprising a backplate and a light source assembly disposed within the backplate, the backplate being a hexahedron which is open at the top, and the light source assembly comprising a light source and a light source support, wherein the backplate has an open side edge that is completely open, and side edges located at two sides of the open side edge are each formed with a snap-fit hole respectively; the light source support is provided with snap-fit elements adapted to be detachably joined with the snap-fit holes, and the light source assembly is inserted into the backplate from the open side edge with the snap-fit elements being mated with the snap-fit holes to fix the light source assembly and the backplate together.

11. The LCD device of claim 10, wherein the snap-fit element comprises:
a stopping support having a first vertical end and a second vertical end spaced apart from each other, wherein the first vertical end is adjacent to one of the side edges having a snap-fit hole and is formed with a through-hole corresponding to the snap-fit hole; and
a dowel pin having one end inserted into the snap-fit hole via the through-hole and the other end abutting against an elastic element.

12. The LCD device of claim 11, wherein a top surface of the end of the dowel pin that is inserted into the snap-fit hole is a convex cambered surface.

13. The LCD device of claim 12, wherein the elastic element is a spring.

14. The LCD device of claim 13, wherein the stopping support is inserted or snap-fitted into the light source support.

15. The LCD device of claim 14, wherein the second vertical end is provided with a locating hole or a locating post for mating with the elastic element, and a first end of the elastic element is located on the second vertical end by means of the locating hole or the locating post.

16. The LCD device of claim 14, wherein the stopping support is disposed in the form of a rectangular archway, with the first vertical end and the second vertical end standing vertically at two sides of the stopping support respectively; the light source support is formed with a first locating groove for mating with the first vertical end and a second locating groove for mating with the second vertical end, a third locating groove for receiving the elastic element is formed between the first locating groove and the second locating groove, and the third locating groove communicates with the first locating groove and is co-axial with the through hole.

17. The LCD device of claim 10, wherein the light source support has a short edge and a long edge perpendicular to the short edge, the short edge connects with the light source and the long edge is adapted to locate the snap-fit element.

18. The LCD device of claim 17, wherein the snap-fit element is a snap-fit tongue protruding from a side surface of the long edge and having elasticity.
